(19) United States
(12) Patent Application Publication
(10) Pub. No.: US 2005/0045774 A1
(43) Pub. Date: Mar. 3, 2005

(54) Laminar flow nacelle for an aircraft engine

(76) Inventor: Barry N. Hocking, Solihull (GB)

Correspondence Address: MANELLI DENISON & SELTER, 2000 M STREET NW SUITE 700, WASHINGTON, DC, 20036-3307, US

(21) Appl. No.: 10/878,513

(22) Filed: Jun. 29, 2004

(30) Foreign Application Priority Data
Jul. 19, 2003 (GB) 0316967.7

(51) Int. Cl. B64C 21/06

(52) U.S. Cl. 244/209

(57) ABSTRACT

A laminar flow nacelle for an aircraft engine, the nacelle having an outer member defining an aerodynamic shape for a fluid, an inner member defining a chamber with the outer member, and an inlet pipe fluidly connecting ambient air with the chamber for ventilation thereof, the nacelle comprises a porous region at a first region of the outer member, the porous region arranged to allow a flow of fluid into a duct, characterised in that the inlet pipe comprises a venturi portion having a narrow low pressure part and the duct is connected to the narrow part to provide suction to the porous region.

The present invention relates to a laminar flow nacelle for an aircraft engine, particularly to a laminar flow nacelle for a gas turbine engine and in particular to a laminar flow nacelle for a turbofan gas turbine engine.

The achievement of laminar flow over the surface of an aircraft may lead to significant drag reduction and hence fuel savings. It is known to delay the transition from laminar to turbulent flow over a surface of an aircraft by applying suction to the surface. The boundary layer is sucked through pores in the surface to prevent the onset of turbulence. This is known as laminar flow control.

It is known to provide laminar flow over the surface of the nacelle of an aircraft engine by sucking the boundary layer from the surface of the nacelle into the interior of the nacelle using ducts, valves and a pump, driven by an electric motor or a fuel powered motor etc. Such prior knowledge includes GB2232132A and U.S. Pat. No. 5,297,765

The problem with this laminar flow arrangement is that the use of ducts, valves and a pump adds weight and complexity to the laminar flow arrangement. There is also a requirement for maintenance of the laminar flow arrangement and therefore there is a need for access panels in the outer member of the nacelle. Access panels in the outer member of the nacelle produce perturbations in the flow over the outer member of the nacelle and increase drag.

GB2285669A recites a nacelle having inlet openings on its outer surface through which the boundary layer of air is drawn. A duct connects the inlet openings to a discharge opening downstream thereof and is intersected by a further duct open to the inner surface of the nacelle. At the intersection a suction pump is provided and which is driven by the air from the inner duct, thus removing the boundary layer on the outer nacelle surface. The problem with this arrangement is that the inner inlet opening is a significant parasitic loss to engine performance as the inlet is downstream of the propulsive fan.

Accordingly the present invention seeks to provide a novel laminar flow nacelle for an aircraft engine, which reduces the above-mentioned problems.

Accordingly the present invention provides a laminar flow nacelle for an aircraft engine, the nacelle having an outer member defining an aerodynamic shape for a fluid, an inner member defining a chamber with the outer member, and an inlet pipe fluidly connecting ambient air with the chamber for ventilation thereof, the nacelle comprises a porous region at a first region of the outer member, the porous region arranged to allow a flow of fluid into a duct, characterised in that the inlet pipe comprises a venturi portion having a narrow low pressure part and the duct is connected to the narrow part to provide suction to the porous region.

Preferably an array of inlet pipes and an array of ducts are provided, each duct is connected to a narrow part of each pipe.

Preferably, the aircraft engine is a gas turbine engine and is a turbofan gas turbine engine.

According to a second aspect of the present invention a laminar flow surface for an aircraft, comprises the surface having an outer member defining an aerodynamic shape for a fluid, an inner member defining a chamber with the outer member, and an inlet pipe fluidly connecting ambient air with the chamber for ventilation thereof, the surface comprises a porous region at a first region of the outer member, the porous region arranged to allow a flow of fluid into a duct, characterised in that the inlet pipe comprises a venturi portion having a narrow low pressure part and the duct is connected to the narrow part to provide suction to the porous region.

Preferably, the surface is a nacelle of an aircraft engine; alternatively the laminar flow surface is an upper surface of a wing of an aircraft.

The present invention will be more fully described by way of example with reference to the accompanying drawings in which:-

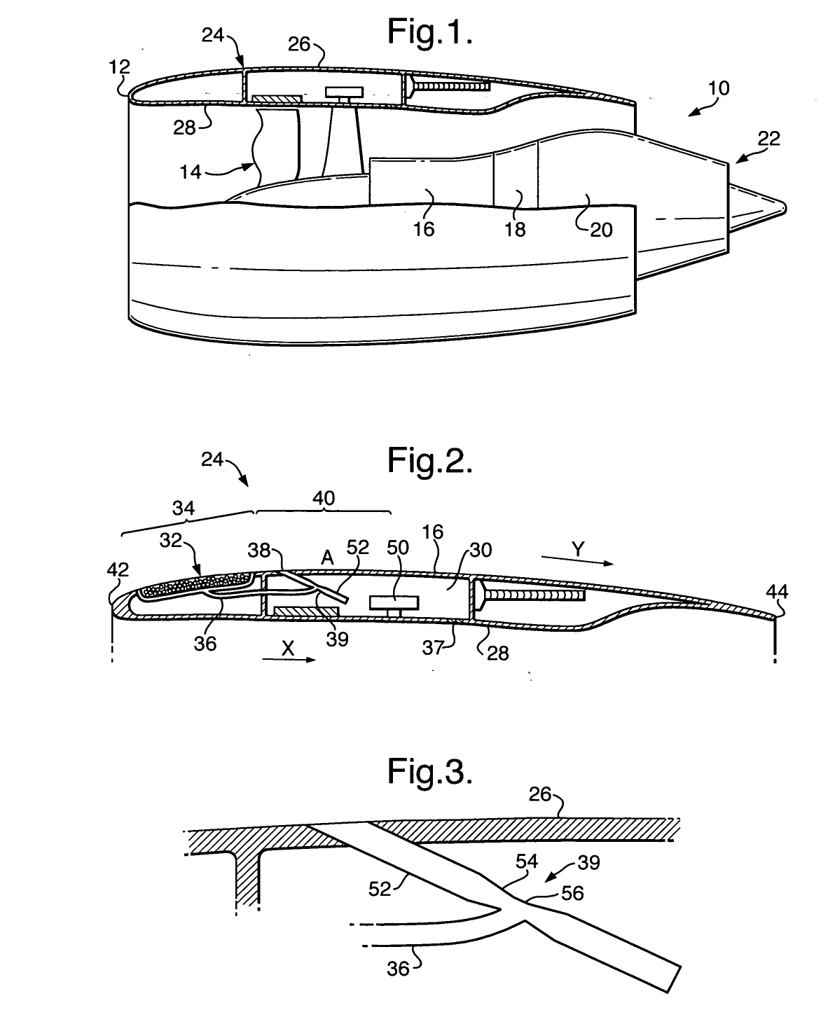

FIG. 1 is a view of a turbofan gas turbine engine having a laminar flow nacelle according to the present invention.

FIG. 2 is an enlarged cross-sectional view through the laminar flow nacelle shown in FIG. 1.

FIG. 3 is a further enlarged cross-sectional view of a porous region of the laminar flow nacelle shown in FIG. 2.

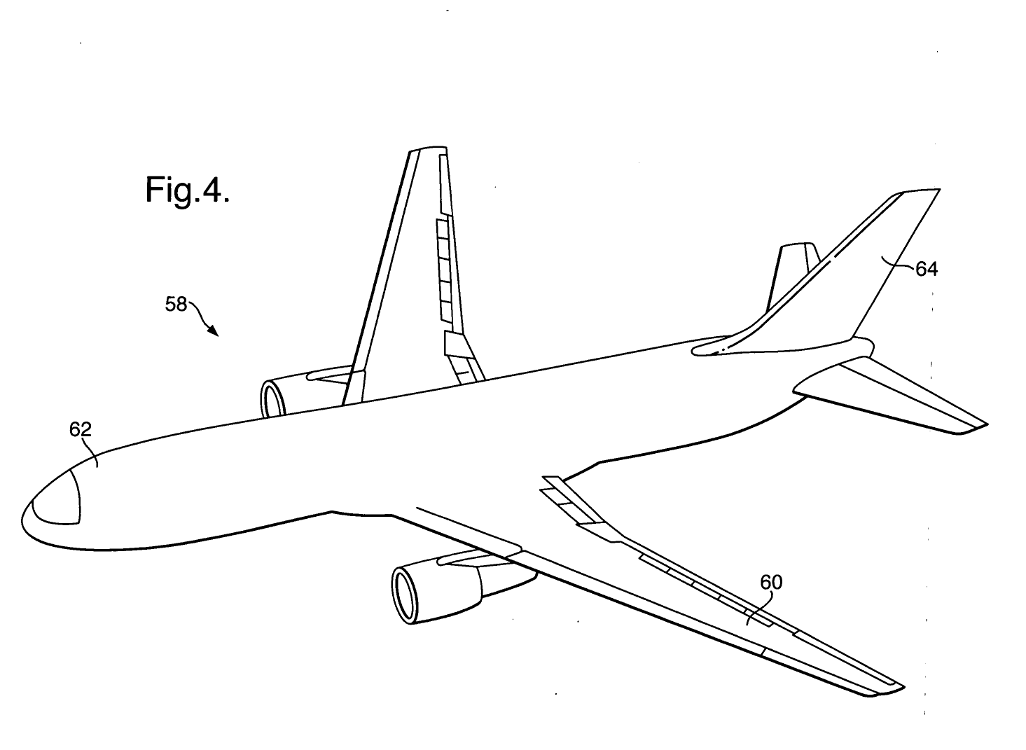

FIG. 4 is a view of an aircraft incorporating an embodiment of the present invention.

A turbofan gas turbine engine 10, as shown in FIG. 1, comprises in axial flow series an intake 12, a fan section 14, a compressor section 16, a combustion section 18, a turbine section 20 and an exhaust nozzle 22. The turbine section 20 comprises one or more low-pressure turbines (not shown) to drive a fan 14 in the fan section 14 and one or more high-pressures to drive a high-pressure compressor (not shown) in the compressor section (16). The turbine section 20 may also comprise one or more intermediate-pressure turbines (not shown) to drive an intermediate-pressure compressor (not shown) in the compressor section 16.

The turbofan gas turbine engine 10 also comprises a nacelle 24, as shown more clearly in FIG. 2, which is arranged coaxially with the turbofan gas turbine engine 10. The nacelle 24 has an outer member 26 defining a generally convex aerodynamic shaped surface and the nacelle 24 has an inner member 28 defining a generally annular chamber 30 with the outer member 26 of the nacelle 24.

Mounted within the chamber 30 are engine accessories 50. These accessories 50 comprise an engine gearbox, an oil filter, an electronic engine control and associated engine ducting and piping. The chamber 30 is a fire zone and there is a requirement to ventilate the chamber 30 to prevent a build up of flammable gases and to provide cooling air for the various accessories 50 mounted on a fan case in the chamber 30. Ventilation is provided by at least one inlet pipe 52 having an inlet 38 defined in the outer member 26, thereby fluidly connecting ambient air to the chamber 30. An outlet 37, in the form of a grill 37, is provided in the inner member 28 for the outlet of the gases from the chamber 30. Alternatively the grill 37 may be provided in the outer member 26 and in particular in a can cowl door of the nacelle. Nonetheless the grill 37 is positioned so that the static pressure adjacent the grill 37 is lower than the static pressure adjacent the inlet 38.

The outer member 26 of the nacelle 24 has a porous region 32 at a first region 34 of the outer member 26 and the porous region 32 allows a flow of fluid into the chamber 30 via at least one duct 36. The at least one duct 36 is connected to the inlet pipe 52 at a junction 39.

The present invention relates to a configuration of the junction 39 that is capable of sucking fluid through the porous region 32 and through the duct 36. The junction 39 is arranged so that the inlet pipe 52 comprises a Venturi portion 54 and the duct 36 is connected to a narrow part 56 of the Venturi portion 54. At the narrow part 56 the fluid flowing through the inlet pipe 52 is at a relatively low pressure, significantly lower than ambient pressure adjacent the first portion 34 of the nacelle. In this way fluid is drawn from the lamina flow over the nacelle 24 improving aerodynamics and reducing drag. One important advantage of this arrangement is that it is self powering, needing no external pump or other mechanical device. Furthermore, there are no working parts to be serviced and offers the advantage of very high reliability.

The nacelle 24 has a highlight at its upstream end 42 and the nacelle 24 has a chord length extending from the upstream end 42 to a downstream end 44.

The first region 34 of the outer member 26 extends between a position at 5% of the chord length of the nacelle 42 from the highlight 42 to a position at 25% of the chord length of the nacelle 24 from the highlight 42 of the nacelle 24. Preferably the first region 34 extends between a position at 10% of the chord length of the nacelle 24 from the highlight 42 to a position at 20% of the chord length of the nacelle 24 from the highlight 42 of the nacelle 24.

The second region 40 of the outer member 26 extends between a position at 50% of the chord length of the nacelle 24 from the highlight 42 to a position at 70% of the chord length of the nacelle 24 from the highlight 42 of the nacelle 24. Preferably the second region 40 extends between a position at 55% of the chord length of the nacelle 24 from the highlight 42 to a position at 65% of the chord length of the nacelle 24 from the highlight 43 of the nacelle 24.

The porous region 32 at the first region 34 of the nacelle 24 is as described in the Applicants co-pending UK application GB0312279.3 filed on 29 May 2003, which is incorporated by reference herein. Briefly however, the porous region 32 comprises a foam structure, which is porous. Alternatively, the porous foam members may comprise porous metal foam or porous plastic foam or other suitable porous foam. Still further the porous region 32 may alternatively comprise an annular perforated member, or a number of part annular perforated members and the perforated member comprises a perforated metal member or a perforated composite member.

The region 34 of the outer member 26 of the nacelle 24 between a position at 25% of the chord length of the nacelle 24 from the highlight 42 to a position at 45% of the chord length of the nacelle 24 from the highlight 42 is arranged to provide a laminar flow by ensuring that there are no access panels.

In operation during flight, at least during cruise conditions of the aircraft, there is an internal fluid, air, flow X through the nacelle 24 to the turbofan gas turbine engine 10 and an external fluid, air, flow Y over the outer member 26 of the nacelle 24. Due to the aerodynamic shape of the outer member 26 of the nacelle 24 a favourable pressure gradient is generated around the profile of the nacelle 24. In particular the static pressure at the first region 34 of the nacelle 24 is greater than the static pressure at the second region 40 of the nacelle 24 and therefore the static pressure at the first region 34 of the nacelle 24 is greater than the static pressure in the chamber 30 within the nacelle 24 due to the interconnection of the chamber 30 and the second region 40 by the duct, or ducts, 36. This pressure difference causes at least some of the boundary layer of the fluid, air, on the first region 34 of the nacelle 24 to flow through the porous region 32 at the first region 34 of the nacelle 24 into the chamber 30 and then through the duct, or ducts, 36 to the at least one aperture 38 at the second region 40 of the nacelle 24. The suction of the boundary layer from the first region 34 of the outer member 26 of the nacelle 24 reduces drag and therefore increases efficiency of the turbofan gas turbine engine 10, particularly at cruise conditions. The pressure gradient of the flow on the aerodynamic surface of the outer member 26 of the nacelle 24 allows a laminar flow type of boundary layer to settle from the nacelle 24 highlight 42 over a significant chord wise length, approximately 30% to 60% of the chord length.

The advantage of the present invention is that there is no need for a pump, valve and associated ducts to bleed the boundary layer from the outer member of the nacelle as in the prior art. This reduces the weight and complexity of the laminar flow arrangement. Also the laminar flow arrangement has a requirement for low maintenance and therefore the need for access panels in the outer member of the nacelle is reduced. The removal of the access panels in the outer member of the nacelle reduced perturbations in the flow over the outer member of the nacelle and therefore reduces drag.

Although the present invention has been described with reference to a turbofan gas turbine engine, the present invention is applicable to other aircraft engines.

Referring now to FIG. 4, although the present invention has been described with reference to a laminar flow nacelle for an aircraft engine, the present invention may be applicable to a laminar flow surface of an upper, convex, surface of an aircraft's 58 wing 60, tail-plane 64 or fuselage 62.

1. A laminar flow nacelle for an aircraft engine, the nacelle having an outer member defining an aerodynamic shape, an inner member defining a chamber with the outer member, and an inlet pipe fluidly connecting ambient air with the chamber for ventilation thereof, the nacelle comprises a porous region at a first region of the outer member, the porous region arranged to allow a flow of fluid into a duct, characterised in that the inlet pipe comprises a venturi portion having a narrow low pressure part and the duct is connected to the narrow part to provide suction to the porous region.

2. A laminar flow nacelle as claimed in claim 1 wherein an array of inlet pipes and an array of ducts are provided, each duct is connected to the narrow part of each pipe.

3. A laminar flow nacelle as claimed in claim 1 wherein the aircraft engine is a gas turbine engine.

4. A laminar flow nacelle as claimed in claim 3 wherein the gas turbine engine is a turbofan gas turbine engine.

5. A laminar flow surface for an aircraft, the surface having an outer member defining an aerodynamic shape, an inner member defining a chamber with the outer member, and an inlet pipe fluidly connecting ambient air with the chamber for ventilation thereof, the surface comprises a porous region at a first region of the outer member, the porous region arranged to allow a flow of fluid into a duct, characterised in that the inlet pipe comprises a venturi portion having a narrow low pressure part and the duct is connected to the narrow part to provide suction to the porous region.

6. A laminar flow surface as claimed in claim 5 wherein the surface is a nacelle of an aircraft engine.

7. A laminar flow surface as claimed in claim 5 wherein the surface is an upper surface of a wing of an aircraft.
